(19) United States
(12) Patent Application Publication
(10) Pub. No.: US 2009/0034376 A1
(43) Pub. Date: Feb. 5, 2009

(54) OPTICAL DISC DEVICE AND RECORDING METHOD AS WELL AS RECORDING PARAMETER SETTING METHOD

(75) Inventors: Tatsuji ASHITANI, Yokohama-shi (JP); Takahiko MIHARA, Kawasaki-shi (JP); Yuichi ITO, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/184,193

(22) Filed: Jul. 31, 2008

(30) Foreign Application Priority Data
Jul. 31, 2007 (JP) 2007-199455

(51) Int. Cl. G11B 5/00

(52) U.S. Cl. 369/47.5

(57) ABSTRACT

According to one embodiment, a plurality of conditions are simultaneously recorded for a power in a combination of power and strategy conditions which are parameters to be adjusted, such that the number of seeks required for a feedback can be reduced, and time for an automatic adjustment required at a rising edge can be reduced.

### CROSS-REFERENCE TO RELATED APPLICATIONS

This application is based upon and claims the benefit of priority from Japanese Patent Application No. 2007-199455, filed Jul. 31, 2007, the entire contents of which are incorporated herein by reference.

### BACKGROUND

1. Field

One embodiment of the invention relates to an optical disc device and a recording method as well as a recording parameter setting method capable of suitably setting recording parameters typified by a write strategy and power.

2. Description of the Related Art

It has been a long time since information recording media capable of recording and reproducing information using laser light, that is to say, optical discs were put to practical use. On the other hand, in regard to standards of the optical discs, a digital versatile disc (DVD) standard has been put into practical use following a compact disc (CD) standard, and a high definition HD DVD standard which has further increased the density of the DVD standard is already in practical use.

In addition, a -R type (write-once-read-many type) and an RW/RAM type (recording-reproducing/rewritable type) are prepared in all of the CD standard, the DVD standard and the HD DVD standard. Particularly in the DVD standard and the HD DVD standard, a test write zone for setting suitable recording parameters, for example, a write power and/or write strategy, etc., is prepared so that the shape of a recording mark (pit) line may be contained in a standard value, that is to say, a predetermined managed width, in consideration of reproduction performed by an optical disc device different from an optical disc device which has performed recording.

For example, Japanese Patent Application Publication (KOKAI) No. 2004-063024 has disclosed a recording compensation method and a recording-reproducing device for optimizing the power and the strategy in order in accordance with a predetermined procedure.

For example, Japanese Patent Application Publication (KOKAI) No. 2006-338724 has disclosed an optical disc device for performing correction and recording in accordance with a write strategy while sequentially changing recording power, and determining optimum recording power on the basis of a resulting reproduction signal, and then determining an optimum strategy at the optimum recording power.

However, in the method disclosed in the Publication (KOKAI) No. 2006-338724, when a certain index (e.g., the displacement of an edge and β, γ) is used to optimize the power and strategy, a global optimum solution might not be reached as there are a plurality of optimum combinations and as there is a local optimum solution in each of the power and strategy in the case where signal integrity at a plurality of points has a difference that can be described as significant, that is to say, in the case of a viewpoint based on signal integrity.

On the other hand, in the method disclosed in the Publication (KOKAI) No. 2006-338724, it is absolutely obvious that first identifying the optimum power and then fixing the power and identifying the optimum strategy increase the time recuired before a suitable power and strategy are set. In addition, there are many kinds of processing to be performed at the rising edge of an optical disc drive, such as the judgment of a disc, the management of copyright protection information, reading of control data peculiar to the disc, the adjustment of servo/power, etc., so that an increase in adjustment time (time required before a power and a strategy are set) has to be avoided.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing one example of an optical disc device to which an embodiment of this invention is applied;

FIG. 2 is a flowchart one example of a procedure for identifying power and a strategy applied to the optical disc device shown in FIG. 1, according to an embodiment of the invention;

FIG. 3 is an exemplary diagram exemplifying the number of recordings and measurements (reproductions) necessary in the procedure (flow) shown in FIG. 2, according to an embodiment of the invention;

FIG. 4 is a flowchart showing another example of a procedure for identifying a power and a strategy applied to the optical disc device shown in FIG. 1, according to an embodiment of the invention;

FIG. 5 is an exemplary diagram exemplifying the number of recordings and measurements (reproductions) necessary in the procedure (flow) shown in FIG. 4, according to an embodiment of the invention;

FIG. 6 is an exemplary diagram exemplifying an example in which the number of recordings and measurements (reproductions) necessary in the procedure (flow) is different from that in the example shown in FIG. 3;

FIG. 7 is an exemplary diagram exemplifying the number of recordings and measurements (reproductions) necessary when the procedure (flow) shown in FIG. 4 is applied to the recording and measurements (reproductions) shown in FIG. 6, according to an embodiment of the invention; and

FIGS. 8A to 8D are exemplary diagrams each showing the recording of information on a recording medium to which one embodiment of this invention is applied and the shape of a recording waveform.

### DETAILED DESCRIPTION

Various embodiments according to the invention will be described hereinafter with reference to the accompanying drawings. In general, according to one embodiment of the invention, a plurality of conditions are simultaneously recorded for a power in a combination of power and strategy conditions which are parameters to be adjusted, such that the number of seeks required for a feedback can be reduced, and time for an automatic adjustment required at a rising edge can be reduced.

Embodiments of this invention will be described in detail with reference to the drawings.

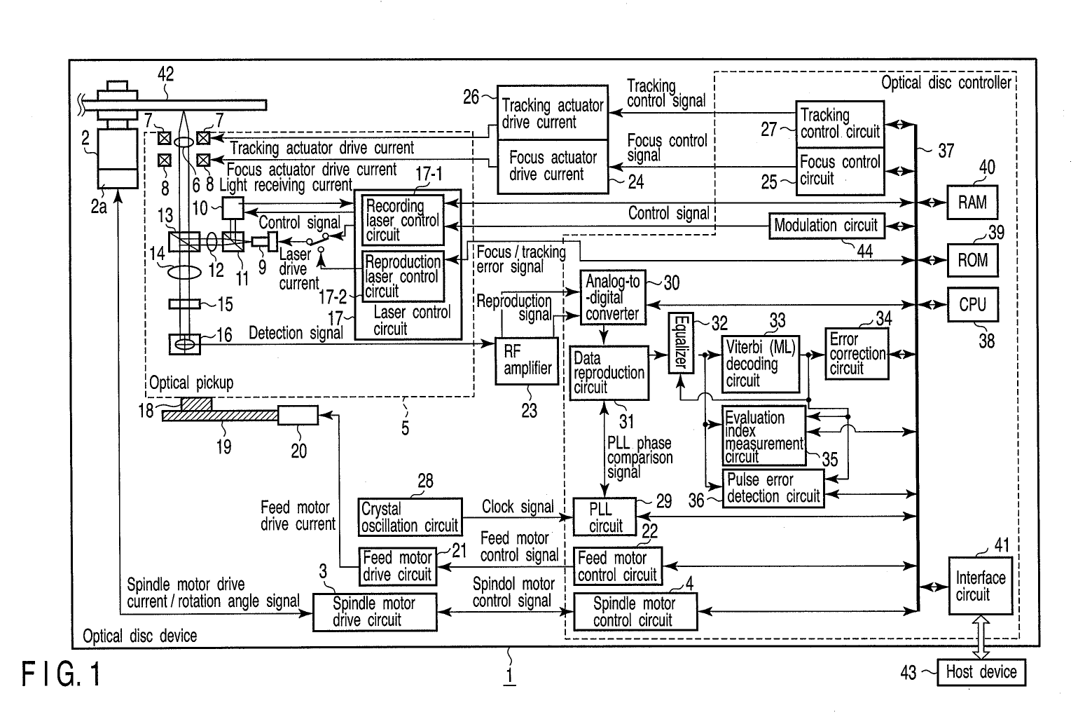

An optical disc device 1 shown in FIG. 1 records and reproduces information on an optical disc 42 as an information recording medium typified by, for example, a DVD-R/RW disc and a high-definition (HD) DVD-R/RW disc. A groove is concentrically or spirally cut in the optical disc 42. A concave portion of the groove is called a land while a convex portion of the groove is called a groove, and one round of the groove or land is called a track.

Laser light of a write power whose strength has been modified in accordance with data to be recorded is applied along the track (the groove alone or the groove and land) to form a recording mark, such that user data is recorded on the optical disc 42. The reproduction of the data is achieved by applying laser light of read power weaker than that in recording along the track (or a mark (pit) line in a playback-only disc) and thereby detecting a change in the strength of light reflected by the recording mark. The erasure of the data is achieved by applying laser light of erase power stronger than that the read power along the track and thereby crystallizing a recording layer.

The optical disc 42 is rotationally driven by a spindle motor 2. A rotation angle signal is output to a spindle motor drive circuit 3 from a rotary encoder 2a integrally provided in the spindle motor 2. One rotation of the spindle motor 2 produces, for example, five pulses of the rotation angle signal. This enables a spindle motor control circuit 4 to judge the rotation angle and rotation number of the spindle motor 2 on the basis of the rotation angle signal input from the rotary encoder 2a via the spindle motor drive circuit 3, thereby controlling the rotation of the spindle motor 2.

The recording of information on the optical disc 42 or the reproduction of information from the optical disc 42 is achieved by an optical pickup head (PUH) 5. The optical pickup head 5 is coupled to a feed motor 20 via a gear 18 and a screw shaft 19. The feed motor 20 is controlled by a feed motor drive circuit 21. The feed motor 20 is rotated by a feed motor drive current supplied from the feed motor drive circuit 21, such that the optical pickup head 5 moves in the radial direction of the optical disc 42.

An objective lens 6 is provided in the optical pickup head 5 by an unshown wire or leaf spring or a housing (resin spring) with a predetermined shape. The objective lens 6 collects the above-mentioned laser light onto the track on a recording surface of the optical disc 42. The objective lens 6 also captures reflected laser light reflected from the recording mark of the track (a recording mark line in a playback-only disc).

The objective lens 6 can be moved in a focusing direction (the optical axis direction of the lens) by a focus actuator 8, and can also be moved in a tracking direction (a direction perpendicular to the optical axis of the lens and along the radial direction of the optical disc) by a tracking actuator 7.

A laser control circuit 17 includes a recording laser control circuit 17-1 for generating a laser control signal to control a laser diode 9 in recording, and a reproduction laser control circuit 17-2 for generating a laser control signal to control the laser diode 9 in reproduction. In recording information (the formation of a mark), the laser control circuit 17 supplies a write signal to the laser diode (laser light emitting element) 9 on the basis of recording data (recording data modulated by, for example, an EFM modulation scheme in a modulation circuit 44) supplied from a host device 43 via an interface circuit 41. In reading information, the laser control circuit 17 supplies the laser diode 9 with a read signal smaller than the write signal. In addition, information for the fine adjustment of edge timing for each code length pattern (hereinafter referred to as edge timing fine adjustment information) which is called a write strategy used when the user data is recorded on the optical disc 42 has been preset in the laser control circuit 17. A laser drive current (laser control signal) whose edge timing has been adjusted on the basis of this edge timing fine adjustment information is output to the laser diode 9.

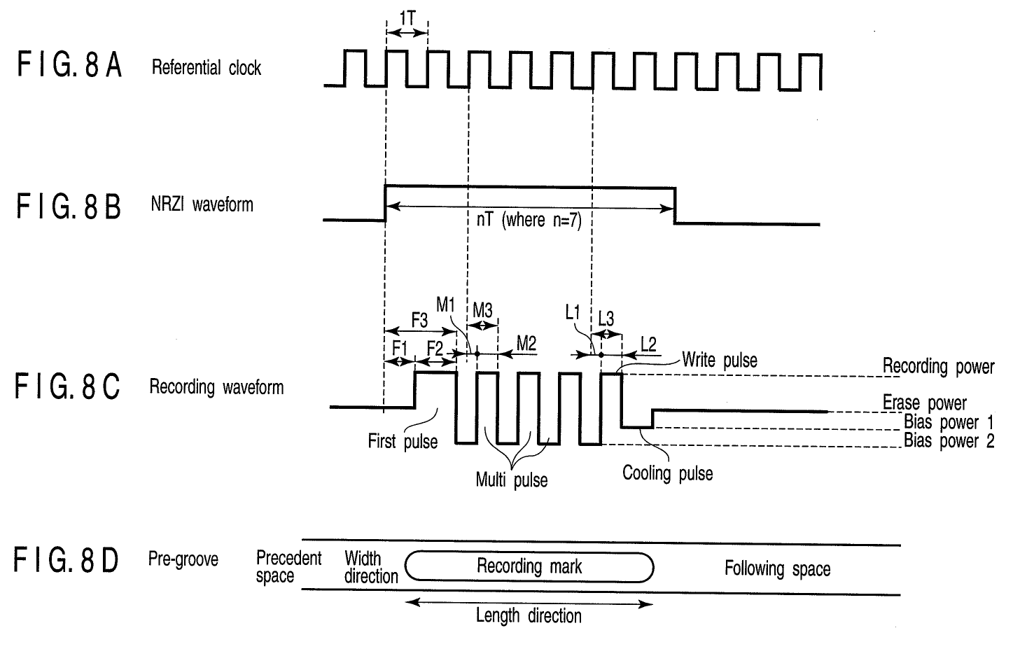

The relation between the strategy and the power is shown in FIGS. 8A to 8D.

FIG. 8A is an exemplary diagram of a signal of a referential clock used by the optical disc. FIG. 8B shows recording data converted into a non return to zero invert (NRZI, a method of matching the edge portion/border portion of the recording mark or pit to the position of “1”) format. FIG. 8C shows one example of the shape of a recording waveform. FIG. 8D is an exemplary diagram showing the shape of a recording mark recorded on a pre-groove. Here, the recording waveform has been set so that a plurality of pulses may be used to record one mark.

One at the head of the plurality of pulses is called a first pulse, and the last one is called a last pulse, and ones in between are called multi pulses. A part is provided after the last pulse to output a bias power 1 (cooling pulse).

In the case of FIG. 8C, the shape of the recording waveform is prescribed on four levels in a level direction: the recording power, the erase power, the bias power 1 and a bias power 2. Likewise, in the time direction of the recording waveform, the shape of the recording waveform is prescribed, on the basis of the rising edge of data in the NRZI format and a clock signal, by time information such as a start time F1 of the first pulse (longer than 1T, where “T” is a “1” clock period as indicated in FIG. 8A), an end time F3 of the first pulse and an interval F2 of the first pulse. Further, regarding parameters which easily affect the formation of the recording mark in particular such as the start time F1 of the first pulse and an end time L3 of the last pulse (shorter than 1T), the intervals are dynamically changed during recording in accordance with the pattern of the NRZI signal.

Such information is saved in a RAM 40 (in FIG. 1) of the device and also saved on the disc as format information. When recording learning is carried out, these parameters are adjusted on the basis of a test-written reproduction signal of the recording mark.

A front monitor photodiode 10 detects an amount of light branched in a given ratio by a half mirror 11 out of the laser light generated by the laser diode 9, that is to say, detects a light reception signal proportionate to irradiation power, and supplies the detected light reception signal to the laser control circuit 17. The laser control circuit 17 acquires the light reception signal supplied from the front monitor photodiode 10, and controls the laser diode 9 on the basis of the acquired light reception signal so that light may be emitted at the laser power (read power) for reproduction, laser power (write power) for reproduction and laser power (erase power) for erasure that have been preset by a central processing unit (CPU) 38.

The laser diode 9 emits laser light in accordance with the signal supplied from the laser control circuit 17. The laser light emitted from the laser diode 9 is applied onto the optical disc 42 via a collimator lens 12, a half prism 13 and the objective lens 6. Reflected laser light from the optical disc 42 is guided to a photodetector 16 via the objective lens 6, the half prism 13, a collecting lens 14 and a cylindrical lens 15.

The photodetector 16 includes, for example, four photodetecting cells, and the photodetector 16 photoelectrically converts light detected by the individual cells to generate a detection signal, and outputs the generated detection signal to an RF amplifier 23.

The RF amplifier 23 processes the detection signal from the photodetector 16, and generates a focus error signal (FE) indicating a deviation from focus, a tracking error signal (TE) indicating a difference between the beam spot center of the laser light and the center of the track, and a reproduction signal (RF) which is a total sum signal of the detection signals. The RF amplifier 23 supplies an analog-to-digital converter 30 with the generated focus error signal (FE), tracking error signal (TE) and reproduction signal (RF).

A focus control circuit 25 generates a focus control signal in accordance with the focus error signal (FE) loaded from the RF amplifier 23 via the analog-to-digital converter 30, and supplies the generated focus control signal to a focus actuator drive circuit 24. On the basis of the focus control signal supplied from the focus control circuit 25, the focus actuator drive circuit 24 supplies the focus actuator 8 in the focusing direction with a focus actuator drive current for driving the focus actuator 8. Thus, focus servo is performed whereby the laser light is always focused on a recording film of the optical disc 42.

A tracking control circuit 27 generates a tracking control signal in accordance with the tracking error signal (TE) loaded from the RF amplifier 23 via the analog-to-digital converter 30, and supplies the generated tracking control signal to a tracking actuator drive circuit 26. On the basis of the tracking control signal supplied from the tracking control circuit 27, the tracking actuator drive circuit 26 supplies the tracking actuator 7 in the tracking direction with a tracking actuator drive current for driving the tracking actuator 7. Thus, tracking servo is performed whereby the laser light always traces on the track formed on the optical disc 42.

Such focus servo and tracking servo are performed, such that the change of the reflected light from the pit, etc., formed on the track of the optical disc 42 in accordance with recording information is contained in the reproduction signal (RF) which is the total sum signal of the detection signals from the photodetector 16 (photodetecting cells). This reproduction signal is a weak analog signal, and is amplified by the RF amplifier 23 and sampled at a given frequency in the analog-to-digital converter 30 and then supplied to a data reproduction circuit 31.

Furthermore, the data reproduction circuit 31 corrects the amplitude and offset of the reproduction signal supplied from the analog-to-digital converter 30, and outputs the reproduction signal to an equalizer 32 after conversion to a signal synchronized with a reproduction clock signal in a phase-locked loop (PLL) 29.

The equalizer 32 uses an arbitrary partial response (PR) characteristic to convert the reproduction signal input from the data reproduction circuit 31 to an equalized reproduction signal close to the arbitrary PR characteristic, and outputs the converted equalized reproduction signal to a viterbi decoding circuit 33, an evaluation index measurement circuit 35 and a pulse error detection circuit 36.

The viterbi decoding circuit (sometimes referred to as a maximum likelihood (ML) decoding circuit) 33 selects a path having the minimum Euclidean distance from the equalized reproduction signal input from the equalizer 32, and outputs a code length bit sequence corresponding to the selected path to an error correction circuit 34 as decoded data, and also outputs the decoded data to the equalizer 32, the evaluation index measurement circuit 35 and the pulse error detection circuit 36.

On the basis of the equalized reproduction signal and the decoded data respectively input from the equalizer 32 and the viterbi decoding circuit 33, the evaluation index measurement circuit 35 calculates, for example, a partial response signal-to-noise ratio (PRSNR), a simulated bit error rate (SBER) and asymmetry as an evaluation index of the reproduction signal, and supplies data on the calculated PRSNR, SBER, asymmetry, etc., to the CPU 38 via a bus 37. At this point, if the equalized reproduction signal is viterbi-decoded in the viterbi decoding circuit 33, the signal is classified (sorted) by code length (e.g., 2T, 3T, etc., where T indicates a one clock period), and wave height values of the reproduction signal are obtained. Then, an average of the obtained wave height values of the reproduction signal is taken to calculate the asymmetry of the reproduction signal.

On the basis of the equalized reproduction signal and the decoded data respectively input from the equalizer 32 and the viterbi decoding circuit 33, the pulse error detection circuit 36 detects a pulse error of the reproduction signal using a technique disclosed in, for example, Japanese Patent Application Publication (KOKAI) No. 2004-63024.

The CPU 38 performs various kinds of calculation processing on the digital signals such as the focus error (FE) signal and the tracking error (TE) signal output from the RF amplifier 23 and converted into the digital signals via the analog-to-digital converter 30, and controls the spindle motor control circuit 4, a feed motor control circuit 22, the focus control circuit 25 and the tracking control circuit 27.

Furthermore, the laser control circuit 17, the PLL 29, the analog-to-digital converter 30, the error correction circuit 34, the evaluation index measurement circuit 35, the pulse error detection circuit 36, etc., are controlled by the CPU 38 via the bus 37.

The CPU 38 also executes various kinds of processing in accordance with operation commands supplied from the host device 43 via the interface circuit 41 and in accordance with a program stored in a read-only memory (ROM) 39 and a program loaded from the ROM 39 to the random access memory (RAM) 40. The CPU 38 thus generates various control signals and supplies the control signals to various parts, thereby achieving the overall control of the optical disc device 1.

In the meantime, when data is recorded on the optical disc 42, the recording data supplied from the host device 43 is modulated by the modulation circuit 44, and sent to the laser control circuit 17. Timing fine adjustment information and recording power per code pattern called a “recording strategy” (or simply “strategy” or “write strategy”) have been set in the above-mentioned recording laser control circuit 17-1 of the laser control circuit 17, and a laser drive current (write power) whose timing and power have been adjusted on the basis of the above information is passed to the laser diode. Thus, a recording laser beam generated by the light emission of the laser diode is applied to the track on the surface of the optical disc 42 through an optical system, that is to say, the PUH 5.

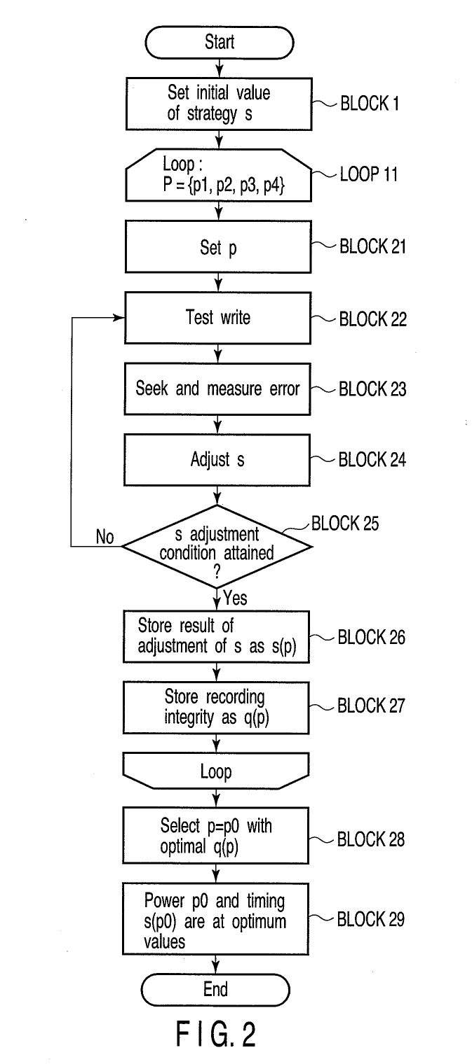

In other words, as shown in FIG. 2, a strategy pulse width whose symmetry is optimum for the power can be identified. This is identified for every combination of candidate recording powers, and if one optimum solution in signal integrity is selected out of the combinations, a power and a strategy can be identified.

Here, a power p is a vector including four parameters, for example, the recording power, the erase power, the bias power 1 and the bias power 2 in FIGS. 8A to 8D. A strategy s is, for example, a matrix in which a vector including parameters (F1, F2, F3, M1, M2, M3, L1, L2) in FIG. 8 is contained in each NRZI code pattern.

More specifically, when an initial value of the strategy s is set (BLOCK 1), a loop [LOOP 11] for changing the power p to p1 to p4 in order is executed.

Hereinafter, an i-th power is indicated as pi, and j-th strategy condition corresponding to pi is indicated as sij.

In addition, by way of example, the loop [LOOP 11] includes:

setting “p1” in p and “s11” in s (BLOCK 21);

performing a test write (BLOCK 22);

causing for the optical pickup head (PUH) 5 to perform a seek, and from the result of a test write by the power set in block 21, identifying an error of a pulse waveform prescribing the strategy s or its timing at that position, that is to say, at a position where the test write has been performed in block 22 (BLOCK 23); and adjusting (changing), for example, the timings F1, L3 having significant influences on the strategy s in accordance with the identified errors, and newly setting s12 in s (BLOCK 24).

The blocks 22 to 25 are repeated until a reproduction waveform produced by the reproduction of a mark recorded by the strategy s reaches a predetermined condition.

The loop [LOOP 11] further includes:

storing the result of the adjustment of s as “s(p1)” (BLOCK 27); and

storing a recording integrity as “q(p1)” (BLOCK 28).

Then, “p2” is set in p, and the loop is executed for p=p2.

Subsequently, the loop is executed for a scheduled maximum number for p, that is to say, up to “p4” in the example of FIG. 2.

In this manner, a recording integrity “q(p)” is identified for p of each of p1 to p4, and p whereby the optimal or nearly optimal “q(p)” is obtained is selected as “p0”, and then the power p0 and the timing (strategy) s (p0) are selected as the optimal parameters (BLOCK 29).

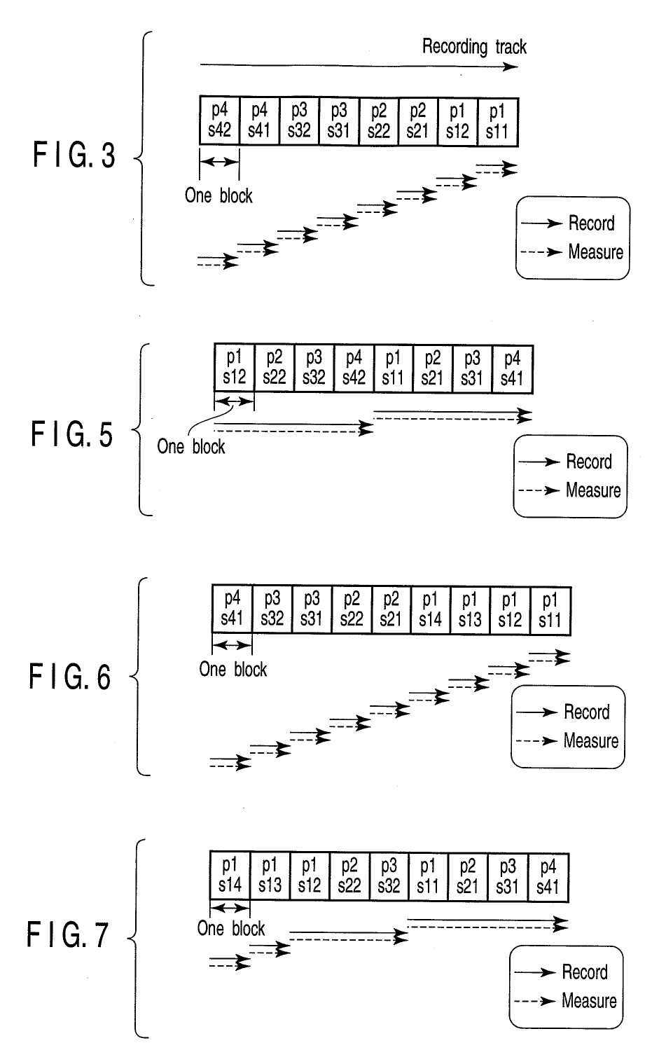

However, the procedure shown in FIG. 2 follows a track in a test write zone, as shown in FIG. 3. One block in FIG. 3 is a unit of a test write, and a unit such as a modulation/demodulation block unit, a physical segment or a sector is used.

In FIG. 3, pi (i=1, 2, 3, 4) written in the block indicates a power condition, and sij (i=1, 2, 3, 4, j=1, 2) indicates a strategy condition at a power pi. The test write zone here assumes a drive test zone (DTZ) and is generally used from the outer periphery to the inner periphery, so that recordings and measurements are alternately carried out in such an order as the recording and the following measurement of p1/s11, the recording and the following measurement of p1/s12, the recording and the following measurement of p2/s21, the recording and the following measurement of p2/s22, the recording and the following measurement of p3/s31, to the recording and the following measurement of p4/s42.

Although several blocks are generally required for the optimization (“s adjustment condition attained” in the flow) of s (strategy), recordings and measurements for four strategies are needed for each power in the example of FIG. 3. In other words, recordings and measurements are repeated for the number of blocks in the example of FIG. 3, and a lens seek (the movement of the objective lens 6, i.e., the PUH 5) is caused for every recording and measurement. Since the recordings and measurements are actually carried out for about the same track, a rotational delay for nearly one round of the disc is caused. Moreover, while a combination of four kinds of powers and two kinds of strategies are shown in FIG. 3 for the simplification of explanation, a greater number of combinations require a longer total adjustment time in reality, which is not preferable in terms of mounting.

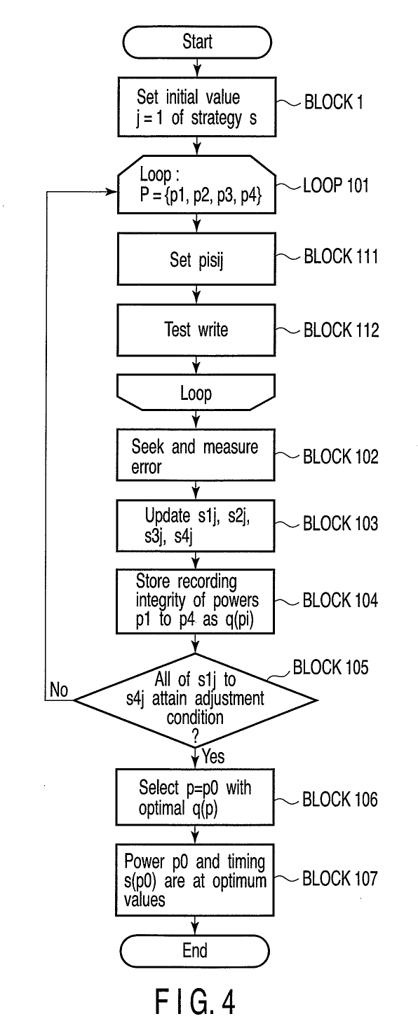

On the contrary, considering the independent adjustment for each power, the factor for the necessity of the path of a readjustment based on measurement is limited to the same power condition as in an update from si1 to si2, so that recordings are simultaneously performed for different powers, and the respective strategy conditions are simultaneously measured and simultaneously updated as shown in FIG. 4 and FIG. 5, thereby making it possible to reduce the number of seeks. Thus, the adjustment under the same condition as FIG. 3 is arranged as in FIG. 5, and the number of seeks can be reduced from sixteen to four.

More specifically, when an initial value of the strategy s is set by block (BLOCK 1) as shown in FIG. 4,

a test write is first performed by a loop [LOOP 101] starting from “p=p1, s=s11” for arbitrary “i, j” from 1 to a scheduled maximum number with regard to p, s.

In other words, p (power) and s (strategy) are respectively converted to variables pi, sij, and a combination of {p1, s11}, {p2, s21}, {p3, s31} and {p4, s41} is selected in the loop (BLOCK 111), and

a test write is performed (BLOCK 112). During this loop, the beam is tracing on the track, and no lens seek is caused. The timing of the switch of the strategy and the power is controlled by, for example, the block, and the switch is simultaneously made with switch timing by a measure such as bank switch.

Subsequently, the optical pickup head (PUH) 5 is caused to perform a seek, and at that position, that is to say, at a position where the test write has been performed in block 112, an error of the strategy s is identified from the result of a test write by the power set in block 111 (BLOCK 102).

On the basis of the result, j of sij is updated by the addition of “1” (BLOCK 103);

a recording integrity “q(pi)” is stored (BLOCK 104); and

all p's of p1 to p4 and s of an arbitrary number associated with pi are updated by the loop [LOOP 101] until all the strategies s1j, s2j, s3j, s4j reach a predetermined condition (BLOCK 105).

Then, p whereby the optimal or nearly optimal “q(p)” is obtained is selected as “p0”, and then the power p0 and the timing (strategy) s (p0) are selected as the optimal parameters (BLOCK 108).

Furthermore, in the case where the number of adjustments of s for each power is different as shown in FIG. 6, that is to say, in the case where the adjustment of s is required four times for p1, two times for p2 and p3 and one time for p4 to satisfy an “s adjustment condition” in the procedure (flow) shown in FIG. 2, the procedure (flow) shown in FIG. 4 can be applied in the same manner to reduce the number of seeks from eighteen to eight, as shown in FIG. 7.

In other words, given that one rotation is about 40 Hz on the assumption that one seek is substantially equal to rotational delay time, a saving of 250 to 300 ms can be made in these two examples. There are many kinds of processing at the rising edge of the optical disc drive, such as the judgment of a disc, the management of copyright protection information, reading of control data peculiar to the disc, servo/power adjustments, etc., so that the reduction of the adjustment time is of great significance.

In addition, the series of processing described in the embodiment of the present invention can be executed by software, but can also be executed by hardware.

Moreover, while the blocks in the flowchart are carried out in a time-series manner in the described order in the example of processing shown in the embodiment of the present invention, the present invention not only includes the time-series processing but also includes processing executed in parallel or individually.

The use of one embodiment of this invention makes it possible to reduce time for an automatic adjustment required at a rising edge and reduce time before the start of recording. It can also provide an optimum recording waveform to an optical disc which is commercialized later than an optical disc device as well as to a disc presented by a new disc manufacturer. Further, it also makes it possible to carry out more (high-level) adjustments within a time secured for the automatic adjustment, so that an improvement in the adaptability to the recording of a disc to be provided can be expected regardless of the disc manufacture or manufacturing time.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc device comprising:
a light source configured to output light of a predetermined intensity;
a driving power supply configured to supply a drive current as a driving force to the light source;
a photodetector configured to detect light of reproduction intensity from the light source reflected by a recording medium and to output a signal corresponding to the intensity of the light;
a first setting module configured to set the intensity of the drive current supplied from the driving power supply to the light source when the light source outputs light of recording intensity;
a second setting module configured to set a pulse waveform or timing of the drive current supplied from the driving power supply to the light source when the light source outputs the light of recording intensity; and
a third setting module configured to fix, at a predetermined intensity, the intensity of the drive current set by the first setting module, and to supply the driving power supply with a combination of the fixed intensity of the drive current and the pulse waveform or timing of the drive current set by the second setting module, and then to change, on the basis of the output from the photodetector, the pulse waveform or timing of the drive current to be set by the second setting module.

2. The optical disc device of claim 1, where p is the intensity of the drive current supplied to the light source and s is the pulse waveform or timing of the drive current supplied to the light source, wherein the third setting module is configured to change p and to perform test writes with a plurality of s's corresponding to the fluctuation of p at the same time.

3. The optical disc device of claim 1, where p is the intensity of the drive current supplied to the light source and s is the pulse waveform or timing of the drive current supplied to the light source, wherein the third setting module is configured to perform test writes with a plurality of s's for each p in a combination of each p and s prescribed as pᵢ, sᵢⱼ (i, j are arbitrary integers).

4. A recording method of an optical disc device, comprising:
outputting light of a predetermined intensity from a light source;
supplying a drive current as a driving force to the light source from a driving power supply;
detecting light of reproduction intensity from the light source reflected by a recording medium;
outputting a signal corresponding to the intensity of the light;
setting an intensity of the drive current when the light source outputs light of recording intensity;
setting a pulse waveform or timing of the drive current when the light source outputs the light of recording intensity;
fixing the intensity of the drive current set by a first setting module to a predetermined intensity;
supplying the driving power supply with a combination of the fixed intensity of the drive current and the pulse waveform or timing of the drive current set by a second setting module;
changing, on the basis of the output from a photodetector, the pulse waveform or timing of the drive current to be set by the second setting module;
performing a test write on an area with the combination of the intensity of the drive current, and the pulse waveform or timing of the drive current;
obtaining a detection result by reproduction of an area where the test write has been performed;
changing the combination of the intensity of the drive current and the pulse waveform or timing of the drive current for a test write in accordance with the detection result at the third setting module;
performing the test write again; and
updating to the intensity of the drive current and the pulse waveform or timing of the drive current resulting a signal of good quality.

5. The recording method of claim 4, further comprising:
changing the intensity of the drive current in the test write,
performing the test writes at one time with the pulse waveforms or timings of a plurality of combinations of drive current corresponding to the fluctuation of the intensity of the drive current, at the same time as the above changing, and
simultaneously updating strategy conditions for the plurality of intensities of the drive currents.

6. The recording method of claim 4, where p is the intensity of the drive current and s is the pulse waveform or timing of the drive current, further comprising:
performing a plurality of test writes with a plurality of s's for each p in a combination of arbitrary p and s prescribed by pᵢ, sᵢⱼ (i, j are arbitrary integers).

7. The recording method of claim 5, where p is the intensity of the drive current and s is the pulse waveform or timing of the drive current, further comprising:
performing a plurality of test writes with a plurality of s's for each p in a combination of each p and s prescribed by pi, sij (i, j are arbitrary integers).

8. A recording method of an optical disc device, comprising:
outputting light of a predetermined intensity from a light source;
supplying a drive current as a driving force to the light source from a driving power supply;
detecting light of reproduction intensity from the light source reflected by a recording medium;
outputting a signal corresponding to the intensity of the light;
setting an intensity of the drive current when the light source outputs light of recording intensity;
setting a pulse waveform or timing of the drive current when the light source outputs the light of recording intensity;
fixing the intensity of the drive current set by a first setting module to a predetermined intensity;
supplying the driving power supply with a combination of the fixed intensity of the drive current and the pulse waveform or timing of the drive current set by a second setting module;
changing, on the basis of the output from a photodetector, the pulse waveform or timing of the drive current to be set by the second setting module;
performing a test write on an area with the combination of the intensity of the drive current, and the pulse waveform or timing of the drive current;
obtaining a detection result by reproduction of an area where the test write has been performed;
changing the combination of the intensity of the drive current and the pulse waveform or timing of the drive current for the test write in accordance with the detection result;
performing the test write again;
updating to the intensity of the drive current and a pulse waveform or timing of the drive current resulting a signal of good quality;
holding a substantially optimal condition of the pulse waveform or timing of the drive current for the intensity of each drive current and a recording quality when the optimal condition is satisfied; and
determining the pulse waveform or timing of the drive current when the recording quality is substantially optimal.

9. The recording method of claim 8, further comprising:
changing the intensity of the drive current in the test write,
performing the test writes with the pulse waveforms or timings of a plurality of combination of drive current corresponding to the fluctuation of the intensity of the drive current at one time; and
simultaneously updating strategy conditions for the plurality of intensities of the drive currents.

10. The recording method of claim 8, where p is the intensity of the drive current and s is the pulse waveform or timing of the drive current, further comprising:
performing each of test writes with a plurality of s's for each p in a combination of arbitrary p and s set by performing a test write by a plurality of s's for arbitrary p in a combination of arbitrary p and s prescribed by pᵢ, sᵢⱼ (i, j are arbitrary integers).

11. The recording method of claim 9, where p is the intensity of the drive current and s is the pulse waveform or timing of the drive current, further comprising:
performing each of test writes with a plurality of s's for each p in a combination of each p and s set by performing a test write by a plurality of s's for each p in a combination of arbitrary p and s prescribed by pᵢ, sᵢⱼ (i, j are arbitrary integers).
